(19) United States
(12) Patent Application Publication
(10) Pub. No.: US 2024/0058199 A1
(43) Pub. Date: Feb. 22, 2024

(54) Mobile Tethered Pelvic Assist Device for Generating Timed Frontal Plane Pelvic Moments During Overground Walking

(71) Applicant: The Trustees of Columbia University in the City of New York, New York, NY (US)

(72) Inventors: Sunil K. AGRAWAL, Newark, DE (US); Danielle STRAMEL, New York, NY (US); Jesus Antonio PRADO DE LA MORA, New York, NY (US)

(73) Assignee: The Trustees of Columbia University in the City of New York, New York, NY (US)

(21) Appl. No.: 18/234,482

(22) Filed: Aug. 16, 2023

Related U.S. Application Data
(60) Provisional application No. 63/407,832, filed on Sep. 19, 2022.
(60) Provisional application No. 63/407,901, filed on Sep. 19, 2022.
(60) Provisional application No. 63/399,069, filed on Aug. 18, 2022.

(51) Int. Cl. A61H 3/04; A61H 1/02

(52) U.S. Cl. CPC A61H 3/04; A61H 1/0244; A61H 2003/007

(57) ABSTRACT

Rehabilitation or ambulation assistance can be provided to a user by sensing at least one first pressure beneath the user's right foot, sensing at least one second pressure beneath the user's left foot, and predicting the user's gait based on the sensed at least one first pressure and the sensed at least one second pressure. A plurality of motors are energized at a plurality of times that are synchronized with phases of the user's gait so that the plurality of motors pull on respective cables at respective times in a coordinated sequence. Each of the cables has a first end affixed to a pelvic belt or harness that is shaped and dimensioned to fit securely on the user's pelvis, and the timing of the energizing is based on the gait predictions.

### CROSS REFERENCE TO RELATED APPLICATIONS

This application claims the benefit of U.S. Provisional Applications 63/399,069 (filed Aug. 18, 2022), 63/407,901 (filed Sep. 19, 2022), and 63/407,832 (filed Sep. 19, 2022) each of which is incorporated herein by reference in its entirety.

### STATEMENT REGARDING FEDERALLY-SPONSORED RESEARCH

This invention was made with government support under grant HD100209 awarded by the National Institutes of Health and the National Institute of Child Health and Human Development. The government has certain rights in the invention.

### BACKGROUND

Robotic devices designed for gait training can cyclically apply repeatable forces to specific joints or segments of the user's body while the user walks overground. Robotic gait training can improve overground ambulation for individuals with poor control over pelvic motion.

### SUMMARY OF THE INVENTION

One aspect of this application is directed to a first apparatus for rehabilitating or assisting ambulation of a user. The first apparatus comprises a walker frame, at least one sensor, a first controller, a pelvic belt or harness, a plurality of cables, a plurality of actuators, and a second controller. The at least one sensor is configured to generate data that is indicative of the user's gait. The first controller is configured to predict the user's gait based on the data generated by the at least one sensor. The pelvic belt or harness is shaped and dimensioned to fit securely on the user's pelvis. Each of the plurality of cables has a first end affixed to the pelvic belt or harness. The plurality of actuators are mounted with respect to the frame, and each of the actuators is configured to, when energized, pull on a respective one of the cables. The second controller is programmed to, based on the gait predictions made by the first controller, control the energization of the plurality of actuators at times that are synchronized with phases of the user's gait so that the plurality of actuators pull on the respective cables at respective times in a coordinated sequence.

In some embodiments of the first apparatus, the at least one sensor comprises at least one pressure-sensitive sensor configured for positioning beneath the user's right foot and at least one pressure-sensitive sensor configured for positioning beneath the user's left foot.

In some embodiments of the first apparatus, the first controller maps a predicted gait cycle percentage to an applied pelvic moment using the equation

$${M}_{y} = ( \text{.1} * \underline{{m}_{BW}} ) * ( 0.5 * \underline{{w}_{P}} ) * \underline{\underline{sin}} ( \frac{2 * π * {p}_{GC}}{100} ) \qquad ( 1 )$$

where M_{y} is the frontal plane pelvic moment in Nm, m_{BW} is the participant's body weight in N, ω_{P} is the participant's pelvic width in m, and p_{GC} is the participant's predicted right gait cycle output from the gait prediction system from 0 to 100%. Optionally, in these embodiments, after a goal moment has been calculated using equation (1), the second controller optimizes for tensions of the cables using quadratic programming.

In some embodiments of the first apparatus, the first controller and the second controller are both implemented using the same hardware. In some embodiments of the first apparatus, each of the actuators comprises a motor.

Some embodiments of the first apparatus further comprise a plurality of wheels positioned to support the walker frame.

In some embodiments of the first apparatus, the plurality of cables includes seven cables configured such that two cables route to each of two lateral extremes of the pelvic belt or harness, and three cables route to a posterior extreme of the belt or harness, wherein the seven cables provide control of six degrees of freedom at the pelvis, with the force and moment profiles that are applied being customizable in both magnitudes and force and moment directions.

In some embodiments of the first apparatus, the second controller is further programmed to localize the pelvic center with respect to the frame using a forward kinematics approach that relies on the lengths of the cables.

In some embodiments of the first apparatus, the second controller is programmed so that the coordinated sequence assists ambulation. In some embodiments of the first apparatus, the second controller is programmed so that the coordinated sequence applies a force in opposition to a given muscle in order to rehabilitate the given muscle.

Another aspect of this application is directed to a first method for rehabilitating or assisting ambulation of a user. The first method comprises sensing at least one first pressure beneath the user's right foot and sensing at least one second pressure beneath the user's left foot. The first method also comprises predicting the user's gait based on the sensed at least one first pressure and the sensed at least one second pressure; and energizing a plurality of motors at a plurality of times that are synchronized with phases of the user's gait so that the plurality of motors pull on respective cables at respective times in a coordinated sequence. Each of the cables has a first end affixed to a pelvic belt or harness that is shaped and dimensioned to fit securely on the user's pelvis, and timing of the energizing is based on the gait predictions.

In some instances of the first method, a predicted gait cycle percentage is mapped to an applied pelvic moment using the equation

$${M}_{y} = ( \text{.1} * \underline{{m}_{BW}} ) * ( 0.5 * \underline{{w}_{P}} ) * \underline{\underline{sin}} ( \frac{2 * π * {p}_{GC}}{100} ) \qquad ( 1 )$$

where M_{y} is the frontal plane pelvic moment in Nm, m_{BW} is the participant's body weight in N, ω_{P} is the participant's pelvic width in m, and p_{GC} is the participant's predicted right gait cycle output from the gait prediction system from 0 to 100%.

In some instances of the first method, the cables are configured such that two cables route to each of two lateral extremes of the pelvic belt or harness, and three cables route to a posterior extreme of the belt or harness, wherein the cables provide control of six degrees of freedom at the pelvis, with the force and moment profiles that are applied being customizable in both magnitudes and force and moment directions.

Another aspect of this application is directed to a second apparatus for rehabilitating or assisting ambulation of a user. The second apparatus comprises a walker frame, pressure-sensitive sensors, a first controller, a pelvic belt or harness, at least seven cables, a plurality of motors, and a second controller. At least one of the pressure-sensitive sensors is configured for positioning beneath the user's right foot, and at least one of the pressure-sensitive sensors is configured for positioning beneath the user's left foot. The pressure-sensitive sensors are configured to collectively generate data that is indicative of the user's gait. The first controller is configured to predict the user's gait based on the data generated by the pressure-sensitive sensors. The pelvic belt or harness is shaped and dimensioned to fit securely on the user's pelvis. Each of the at least seven cables has a first end affixed to the pelvic belt or harness. The plurality of motors are mounted with respect to the frame, and each of the motors is configured to, when energized, pull on a respective one of the cables. The second controller is programmed to, based on the gait predictions made by the first controller, control the energization of the plurality of motors at times that are synchronized with phases of the user's gait so that the plurality of motors pull on the respective cables at respective times in a coordinated sequence.

In some embodiments of the second apparatus, the first controller maps a predicted gait cycle percentage to an applied pelvic moment using the equation

$${M}_{y} = ( \text{.1} * \underline{{m}_{BW}} ) * ( 0.5 * \underline{{w}_{P}} ) * \underline{\underline{sin}} ( \frac{2 * π * {p}_{GC}}{100} ) \qquad ( 1 )$$

where M_{y} is the frontal plane pelvic moment in Nm, m_{BW} is the participant's body weight in N, ω_{P} is the participant's pelvic width in m, and p_{GC} is the participant's predicted right gait cycle output from the gait prediction system from 0 to 100%. Optionally, in these embodiments, after a goal moment has been calculated using equation (1), the second controller optimizes for tensions of the cables using quadratic programming.

In some embodiments of the second apparatus, the first controller and the second controller are both implemented using the same hardware.

In some embodiments of the second apparatus, the cables are configured such that two cables route to each of two lateral extremes of the pelvic belt or harness, and three cables route to a posterior extreme of the belt or harness, wherein the cables provide control of six degrees of freedom at the pelvis, with the force and moment profiles that are applied being customizable in both magnitudes and force and moment directions.

In some embodiments of the second apparatus, the second controller is further programmed to localize the pelvic center with respect to the frame using a forward kinematics approach that relies on the lengths of the cables.

### BRIEF DESCRIPTION OF THE DRAWINGS

FIG. 1 shows the mTPAD architecture and a representative pelvic coordinate frame.

FIG. 2 shows how cable tensions create frontal plane pelvic moments.

FIG. 3 shows how the applied pelvic moment is a function of the user's right gait cycle percentage.

FIG. 4 shows an experimental setup for mTPAD data collection.

FIG. 5 shows representative pelvic angles for one study participant.

FIG. 6 shows representative sEMG data from one subject for the left and right gluteus medius muscles.

FIG. 7 shows gait cycle predictions and applied frontal plane moments.

FIG. 8 shows the range of values per stride for all strides and all participants.

FIG. 9 shows the group results of iEMG values per step for the left and right gluteus medius.

FIG. 10 shows the mTPAD mounted to an instrumented treadmill.

FIG. 11 is a block diagram of the mTPAD open-loop high-level controller.

FIG. 12 depicts protocol conditions in three different cases.

FIGS. 13A, 13B, and 13C show stride length, step width, and stride time, respectively.

FIG. 14A and FIG. 14B show the peak averages per condition for the left and right biceps, respectively.

Various embodiments are described in detail below with reference to the accompanying drawings, wherein like reference numerals represent like elements.

### DESCRIPTION OF THE PREFERRED EMBODIMENTS

Chapter One: Mobile Tethered Pelvic Assist Device for Generating Timed Frontal Plane Pelvic Moments During Overground Walking.

There is a need for an overground gait training robotic device that allows full control of pelvic movement and synchronizes applied forces to the user's gait. This chapter describes an overground robotic gait trainer that applies synchronized forces on the user's pelvis, the mobile Tethered Pelvic Assist Device (mTPAD). The mTPAD is described herein, and additional details of mTPAD can be found in D. M. Stramel and S. K. Agrawal, “Validation of a Forward Kinematics Based Controller for a mobile Tethered Pelvic Assist Device to Augment Pelvic Forces during Walking,” Proceedings—IEEE International Conference on Robotics and Automation, pp. 10133-10139, Institute of Electrical and Electronics Engineers (IEEE), September 2020, which is incorporated herein by reference in its entirety.

mTPAD is a portable overground cable-driven gait training device that applies moments on the user's pelvis in the frontal plane, which are synchronized with the user's gait in real-time. mTPAD can apply three dimensional forces that can be translated to overground ambulation. This parallel platform is built upon a posterior rollator and utilizes a waist belt or harness worn around the user's pelvis as its end effector. The direction, magnitude, and duration of the forces and moments applied to the waist can be controlled. The controller for this device uses the predicted gait cycle percentage of the user in real-time to determine the applied force and moment profile on the pelvis.

To illustrate one possible control scheme, we apply an assistive frontal plane pelvic moments synchronized with the user's continuous gait in real-time. Ten healthy adults walked with the robotic device, with and without frontal plane moments. The frontal plane moments corresponded to 10% of the user's body weight with a moment arm of half their pelvic width. The frontal plane moments significantly increased the range of frontal plane pelvic angles from 2.6° to 9.9° and the sagittal and transverse planes from 4.6° to 10.1° and 3.0° to 8.3°, respectively. The frontal plane moments also significantly increased the activation of the left gluteus medius muscle, which assists in regulating pelvic obliquity. The activation of the right gluteus medius muscle did not significantly differ when frontal plane moments were applied. This chapter highlights the ability of the mobile Tethered Pelvic Assist Device to apply a continuous pelvic moment that is synchronized with the user's gait cycle. This capability can change the way overground robotic gait training strategies are designed and applied. The potential for gait training interventions that target gait deficits or muscle weakness can now be implemented with the mobile Tethered Pelvic Assist Device.

### I. Introduction

The pelvis plays an essential role in overground ambulation as it is the intermediate segment between the torso and the lower limbs. Not only do the muscles proximal to the pelvis assist in regulating the center of mass during gait, but the hip musculature, including the gluteus medius muscles, provide frontal plane stability for the pelvis during walking and single stance. Therefore, the coordination and strength of the hip musculature are critical for maintaining balance during overground ambulation.

An individual's ability to ambulate independently directly impacts their quality of life. Improving an individual's coordination and strength at the pelvic level can positively impact their gait for those with atypical or irregular gait patterns. For stroke survivors, lateral pelvic tilt while standing is highly correlated with weight-bearing asymmetry. And notably, exercises that specifically target strengthening of the pelvic muscles can significantly increase overground gait speed.

For children with diplegic cerebral palsy (CP), Kirkwood et al. showed that individuals with gross motor function classification system (GMFCS) level II had significantly reduced pelvic obliquity than level I, highlighting the need for frontal plane rehabilitation strategies for those individuals. For individuals with hip osteoarthritis (OA), in-phase and anti-phase coordination rates between the lumbar and pelvic segments are altered, and decreased range of motion and pelvic obliquity asymmetry are present.

Strengthening the hip musculature and improving pelvis-trunk-lower limb coordination can benefit many individuals. However, the requirement for multiple physical therapists to work with various segments of the human body simultaneously can be challenging, so robotic devices have been developed to assist physical therapists. Introducing robotic devices for gait training allows us to explore the scientific application of forces, trajectories, and prescribed variability to various motions to magnify the potential of gait training. Robotic gait training devices are designed with specific gait training goals in mind and thus vary significantly in architecture design and control implementation.

Each robotic gait training device's architecture allows control of one or more specific joints, and not all devices are designed to allow or control pelvic motion. The pelvis has six degrees of freedom (DOF), three translational and three rotational, and many devices have been used to control and study pelvic motion. Some devices, like the treadmill-based MUCDA and overground RAPBT, focus only on controlling the translational movement of the pelvis. Other devices, like the footplate-based Healbot T and the overground BAR, control only the DOFs in the horizontal plane, i.e., the anteroposterior and mediolateral translation of the pelvis and the horizontal rotation. Complete control over the six DOF is achieved by Mun et al.'s overground robotic walker for pelvic motion support (which controls pelvic translations and horizontal rotation while passively allowing pelvic tilt and obliquity) as well as the treadmill-based device described in V. Vashista et al. “Active Tethered Pelvic Assist Device (A-TPAD) to study force adaptation in human walking,” Proceedings—IEEE International Conference on Robotics and Automation, pp. 718-723, September 2014, which is incorporated herein by reference in its entirety and referred to herein as “TPAD.”

The treadmill-based PAM achieves all DOF except the anteroposterior tilt, and so do both overground NatureGaits and AssistOn-Gait systems. The treadmill-based TPAD achieves complete control over the six DOFs. Many of these devices utilize an architecture comprised of two articulated end effectors located at each lateral pelvic extreme, like the treadmill-based ALTACRO and the overground PA. While various combinations of DOFs can allow the study of different complex pelvic motions, some robotic devices solely focus on activating the frontal pelvic obliquity, like the treadmill-based RGR Trainer and the soft exoskeletal HAA. Once a robotic device's active and passive DOFs have been established, a complementary control must be implemented to assist or train gait movements.

Whether a device is assistive or rehabilitative depends on how it interacts with an individual. For example, in the exoskeletal HAA, a torque is applied to assist the hip abductor, as this torque is applied in parallel to the wearer's hip abductor muscles. However, a force or moment can be applied in opposition to the corresponding musculature to resist and potentially rehabilitate a weaker muscle. This was the methodology of our TPAD work by Kang et al., which applied a downward force on the pelvis, leading to an increase in soleus muscle peaks after training. Some robotic platforms can be both, depending on the workspace of applicable forces and moments and the direction or timing of the applied pelvic forces. To fully tailor these assistive or rehabilitative forces, information about the user's gait is required.

To target and train coordination of the pelvis, robotic devices can be articulated to control specific pelvic motions. Knowing where the individual is within their gait cycle is also important, as the prescribed motions or forces should change with gait progression. The way the gait cycle is used within the control of a robotic device can be discrete or continuous. The gait cycle is broken down into sections for many discrete applications, like stance, swing, preswing, etc., and different loadings or motions are prescribed. Finite state machines (FSM) use inertial measurement units (IMU) or load cell data to determine the present gait phase. For a more continuous force or movement profile, a continuous estimation of the gait cycle percentage can be output from a normalized state space and a reference trajectory or a machine learning algorithm in real-time. These real-time gait cycle segmentation methods, coupled with the articulation of control of pelvic motion, advance the ability to train specific movements and muscles.

Though the aforementioned robotic devices include fine control of pelvic motion, the rigid structures add inertia to the users, altering natural overground gait. Cable-driven parallel devices like TPAD can manipulate the pelvis without adding mass to the individual or constraining natural movement. However, complete control over all pelvic DOFs with minimal restriction during overground gait has previously not been achieved. The embodiments described herein control the pelvis using real-time information from the user. Customized force magnitudes and directions are important to investigating training paradigms targeting specific gait deficits and muscle weaknesses.

TPAD can apply three-dimensional forces and moments to the pelvic center. However, the external motion capture system, high-power electronics, and large frame restrict device portability, so a treadmill is used to facilitate ambulation. Multiple design challenges needed to be considered to achieve complete portability and accommodate overground walking using the TPAD technology. An external motion capture system cannot localize the pelvis within the workspace, which is necessary to calculate cable tensions. All electronics must be battery operated, so the high-power motors cannot be used. The overall size and weight of the device must be small enough to fit through a door and be maneuverable by the user. On top of these, the device structure and cable layout must be sturdy enough that when cable tensions are applied, the device does not shift as a result, but that the pelvis is manipulated with respect to the device. By tackling the design adjustments required to make the TPAD portable, the ability of the TPAD to apply targeted three-dimensional forces can be translated to overground ambulation.

This chapter evaluates an overground cable-driven gait training device that can apply variable forces and moments to the pelvis that are synchronized with the user's gait in real-time, the first of its kind to do so. This parallel platform is built upon a posterior rollator and utilizes a waist belt worn around the user's pelvis as its end effector. The direction, magnitude, and duration of the forces and moments applied to the waist can be controlled. The flexibility of applied pelvic forces allows the mTPAD device to be either assistive or rehabilitative depending on the selected force and moment scheme. In this chapter, an assistive moment is evaluated, as the moment applied is in the opposite direction of the moment created by gravity force acting at the center of mass about the stance leg hip joint. This moment strategy is evaluated as it can be beneficial for individuals with hip drop. The controller for this device uses the predicted gait cycle percentage of the user in real-time to determine the pelvis's applied force and moment profile. The gait cycle percentage is predicted by the DeepSole system, a pair of instrumented insoles and a machine learning algorithm developed by our lab. By combining the mTPAD platform and the DeepSole system, we can apply a frontal plane moment to the individual's pelvis in real-time while ambulating overground. In this way, we can highlight one of the many possible control schemes which can target frontal plane pelvic rotation; a specific gait need that affects many individuals. The DeepSole system is described in A. Prado, X. Cao, X. Ding, and S. K. Agrawal, “Prediction of Gait Cycle Percentage Using Instrumented Shoes with Artificial Neural Networks,” Proceedings—IEEE International Conference on Robotics and Automation, pp. 2834-2840, May 2020, which is incorporated herein by reference in its entirety.

Many force profiles can be implemented on one or more DOFs using the mTPAD, but we will first look at altering frontal plane pelvic rotation in this chapter. In this way, we can highlight one of the many possible control schemes; a control scheme that can be used to target a specific gait need that affects many individuals with weak hip musculature.

### II. System Design

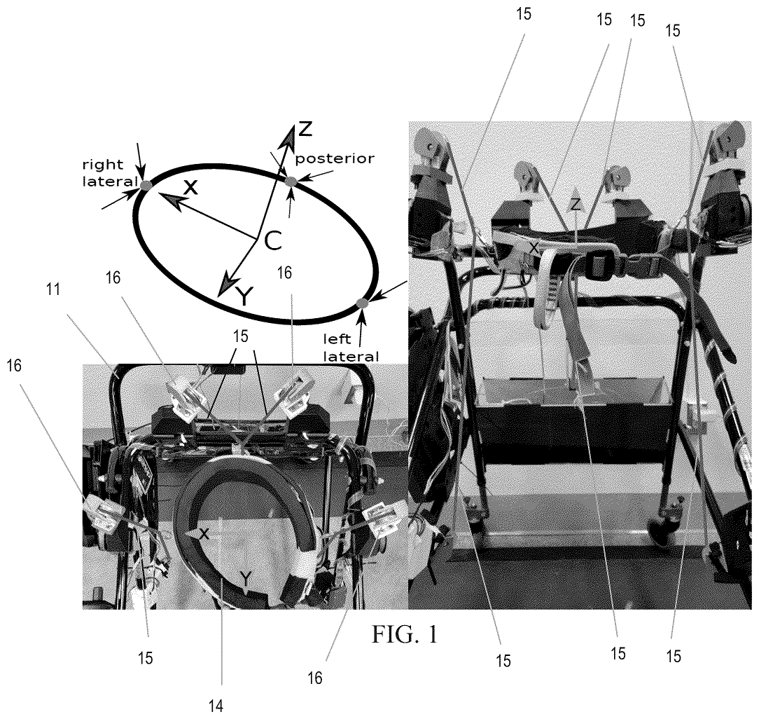

A. System Setup: The timed pelvic moments in this experiment were applied using the mTPAD, a parallel, cable-driven system with seven actuated cables, as shown in FIG. 1. The frame of this device is an off-the-shelf posterior rollator (NIMBO, Inspired by Drive, California). This selection ensures that the device's size and weight remain manageable for users to propel the device forward as they ambulate. Rather than the high power motors used by the TPAD, Dynamixel servo motors 16 (XM430W350-R, ROBOTIS, Seoul, South Korea) are used to provide the tension in each cable. These servo motors 16, coupled with a 3D-printed cable spool, can apply nearly 70 N per cable. Although the TPAD incorporates external tension sensors in line with each cable to have closed-loop control over cable tensions, these external sensors are not used in the mTPAD, as they would be difficult to route in such a tight pelvic workspace. Therefore, the mTPAD utilizes an open loop controller of the servo torques.

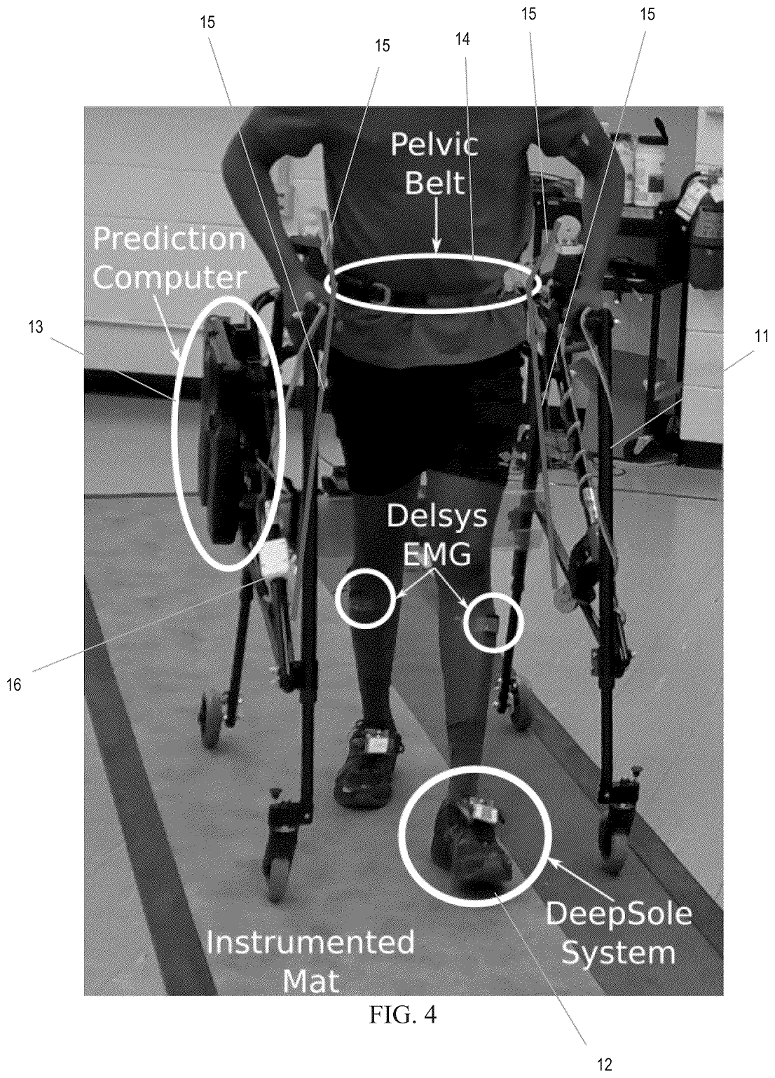

FIG. 1 shows the mTPAD architecture and representative pelvic coordinate frame in a walker frame 11. The upper left image illustrates the local pelvic coordinate frame used when applying pelvic forces. The left and right lateral points have two cables 15, while the posterior point has three cables 15. The local x-axis is aligned with the user's frontal plane, and the z-axis is aligned with their vertical axis. The lower left shows a topdown view of the mTPAD with a pelvic belt 14. Heavy lines highlight the seven cables 15 used. The x and y axes are shown, with the z-axis coming out of the page. The right image shows a front view of the walker frame 11 with additional components. Certain components that are not visible in FIG. 1 are shown in FIG. 4 below. The same illustrations highlight the seven cables 15 and x and z axes, with the y-axis coming out of the page.

A considerable challenge of mobilizing the TPAD was the localization of the pelvis. The TPAD relies on a VICON motion capture system to track markers located at specific points on the individual's pelvic anatomy to track the pelvic center in real-time. However, these systems are expensive and limit the usable workspace of the robotic device. Therefore, a novel way of localizing the pelvic center with respect to the mTPAD frame was implement. A forward kinematics approach that uses the cable lengths was implemented in controller 13 (shown in FIG. 4) to solve this problem. Although this method is less accurate, the errors in the x, y, and z directions were on average −0.17 cm, 0.79 cm, and −0.54 cm, respectively.

Even with each of these alterations to the TPAD to create the mTPAD, the mTPAD can still apply specific forces to the user's pelvis. This force is applied using seven cables 15 that route from the mTPAD to the pelvic belt 14 worn by the user. The seven cables 15 that route from the mTPAD frame to the pelvis are configured such that two cables route to each of the two lateral extremes of the pelvic belt, and three cables route to the posterior extreme of the belt. The seven cables 15 provide control of the six DOFs at the pelvis. Due to the configuration of the cable exit points on the rollator frame 11 with respect to the pelvic belt 14, the maximum magnitude of solvable forces and moments per axis vary but are still appropriate for training forces of 10% body weight. Therefore, the force and moment profiles that the mTPAD can apply are customizable in both magnitudes and moment directions.

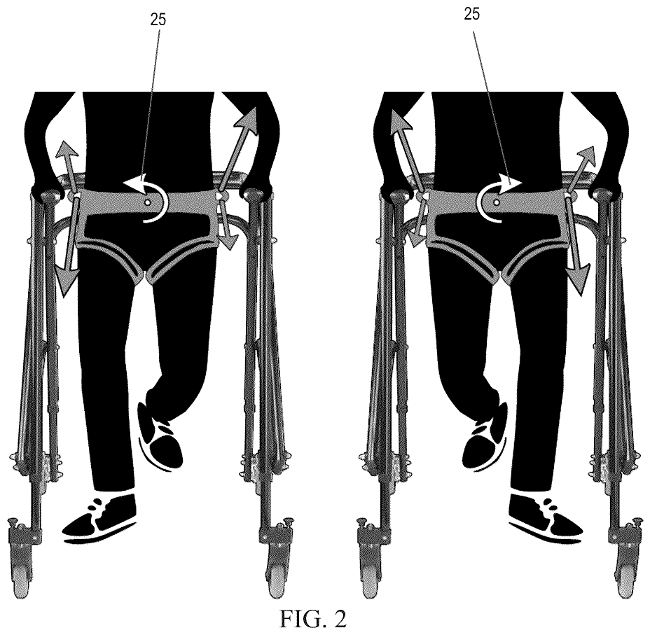

B. Design of the Controller 13: A frontal plane moment is applied to the pelvis. This choice was motivated by frontal plane hip moments, which have a positive bimodal peak distribution from approximately 0% to 55% of the user's gait cycle. Considering both stance legs' hip moments, these alternate in magnitude and direction. A simplification of this is a sine wave, with only one mode per stance leg. This sine wave simplification of a frontal plane pelvic moment is coordinated with the user's gait such that the direction of the moment depends on which leg is in single stance, as shown in FIG. 2. This frontal plane pelvic moment is coordinated with the user's gait such that the direction of the moment depends on which leg is in single stance. The continuous gait cycle percentage was used to determine moment magnitude and direction to avoid any perturbative effects of instantly switching moment directions based on discrete gait phase stages like stance or swing. The continuous mapping requires real-time knowledge of where the user is in their gait cycle. Optionally, instrumented footwear (e.g., DeepSole) can be used to predict the gait cycle percentage of the user in real-time as described in A. Prado, X. Cao, M. T. Robert, A. M. Gordon, and S. K. Agrawal, “Gait Segmentation of Data Collected by Instrumented Shoes Using a Recurrent Neural Network Classifier,” May 2019, which is incorporated herein by reference in its entirety.

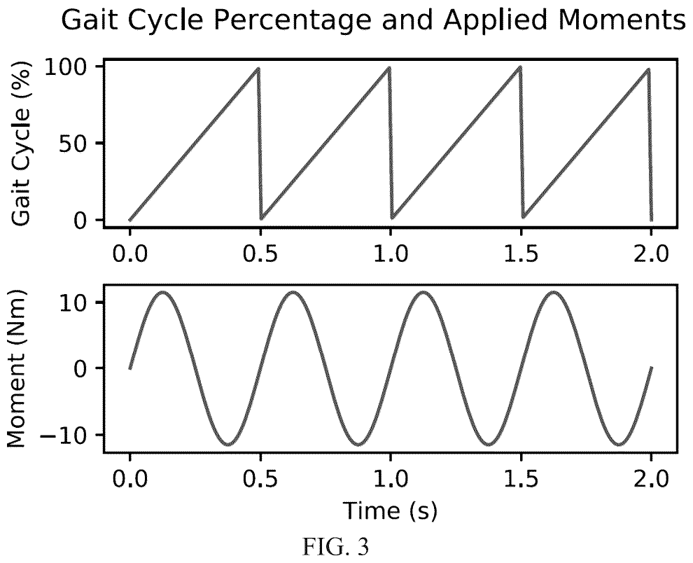

FIG. 2 shows how cable tensions create frontal plane pelvic moments, depicted by the arrows 25 around the pelvic center. Tensions, represented by the remaining arrows with the relative size reflecting the relative cable tensions, are applied by cables routed from motor subassemblies on the walker to the pelvic belt worn by the user. The pelvic moments are synchronized with the phases of the user's gait that correspond to single stance, i.e., a resultant upward force occurs on the contralateral pelvic extreme, and a resultant downward force is applied to the ipsilateral stance belt extreme. All seven cables are required to minimize all other forces and moments.
1) Gait Phase Prediction: The DeepSole system 12 predicts the individual's gait phase percentage in real-time using machine learning. The DeepSole system's gait phase prediction uses pressure and inertial measurement unit (IMU) data from both feet to predict the gait phase percentages of the left and right foot, where 0% corresponds to that foot's heel strike, and 100% corresponds to the instant before the same foot's next heel strike. The gait cycle percentage was based on the right foot for this application.
2) Gait Phase—Moment Mapping: Consideration is required to coordinate the applied frontal moment with the gait cycle. The magnitude and direction of the frontal moment correspond to the stance leg during gait. However, care must be taken not to perturb the individual with a large change in moment magnitude from one time-step to the next. Therefore, a sinusoidal mapping of the gait phase percentage to the applied frontal moment was used to limit gait alterations caused by sudden changes in moment direction and magnitude, as shown in FIG. 3. Equation 1 was used to map the predicted gait cycle percentage to the applied pelvic moment:

$${M}_{y} = ( \text{.1} * {m}_{BW} ) * ( 0.5 * {w}_{P} ) * sin ( \frac{2 * π * {p}_{GC}}{100} ) \qquad ( 1 )$$

where M_{y} is the frontal plane pelvic moment in Nm, m_{BW} is the participant's body weight in N, ω_{P} is the participant's pelvic width in m, and p_{GC} is the participant's predicted right gait cycle output from the gait prediction system from 0 to 100%. as shown in the top of FIG. 3.

FIG. 3 shows how the applied pelvic moment is a function of the user's right gait cycle percentage. Therefore one gait cycle, from the right heel strike to the next right heel strike, can include each moment direction during each leg's stance phase. Zero moments are applied at 0% and 50% of the gait cycle percentage. Therefore, at each foot's heel strike, the moment ramps up to its maximum and back down to zero before the ipsilateral heel strike, which would initiate the opposite moment direction.
3) Tension Optimization: Once the goal moment has been calculated using Equation 1, the mTPAD's high-level controller optimizes for the cable tensions using quadratic programming. The following tension constraints are used in the quadratic programming scheme.

$$min f ( T ) \qquad ( 2 )$$

$$f ( T ) = {T}^{⊤} T , \qquad ( 3 )$$

$${JT}_{ineq} = {F}_{ineq} \qquad ( 4 )$$

$${T}_{min} \leq {T}_{i} \leq {T}_{max} ; \{ \begin{matrix}- 5 N \leq {F}_{x , y , z} \leq 5 N \\ {M}_{- goal} \leq {M}_{y} \leq {M}_{+ goal} \\ - 5 N \cdot m \leq {M}_{x , z} \leq 5 N \cdot m\end{matrix} \qquad ( 5 )$$

where J is the 6×7 system Jacobian, T_{INEQ} is the optimized solution, F_{INEQ} is the force-moment profile associated with the optimized tension solution, T_{MIN}=1 N to ensure taut cables, and T_{MAX}=35 N for safety.

### III. Validation of the System

A dataset of overground walking under multiple conditions was collected from healthy individuals to demonstrate the continuous user-synchronized force application during overground walking. The human response to the frontal plane moments is also investigated. These conditions included walking without the mTPAD and walking with the mTPAD with and without pelvic moments. The experimental protocol and collected dataset were designed to shed light on the following: (i) How well the moment mapping corresponds to the actual gait phase percentage, (ii) If and how the position and orientation of the pelvis during gait are affected by the timed frontal moment, and (iii) If and how the spatiotemporal gait parameters and muscle activity are affected by the timed frontal moment.
A. Experimental Setup: Various data types were collected through a setup shown in FIG. 4 to answer these questions. The left and right predicted gait cycle percentages were output from the DeepSole system at 40 Hz. The mTPAD recorded the local position and orientation of the pelvis, the goal force and moment profile at the pelvis, and the optimized tensions for each of the seven cables at 40 Hz. Delsys Trigno Avanti Sensors recorded surface electromyography (sEMG) signals from the left and right gluteus medius (GM) muscles at 2148 Hz. This muscle was selected for investigation as it assists in regulating pelvic obliquity during overground gait. A Zeno Walkway recorded gait parameters at 120 Hz, which were used to calculate spatial and temporal gait parameters. All of these datasets were time-synchronized using a custom sync box. The sync box receives a transistor-transistor logic (TTL) signal from the Zeno Walkway, which is routed to the sEMG system, and a User Datagram Protocol (UDP) packet is sent to the mTPAD and DeepSole through WiFi.

FIG. 4 shows an experimental setup for mTPAD data collection. An MSI VR One is mounted to the frame of the mTPAD to run the DeepSole Gait Cycle Prediction. Delsys sEMG sensors record GM muscle activity (shown here on the Tibialis Anterior for illustration purposes only, as each user's shorts cover sensors on the GM muscles). The instrumented mat records pressure beneath the feet of the individual as they walk overground. Cables (four of which are marked with ref. no. 15, with the three posterior cables occluded by the user) that route from the mTPAD frame to the pelvic belt apply a force and moment to the pelvis as the participant walks.
B. Protocol: This experiment was completed by 10 healthy participants (age: 28±3 years, height: 169±11.3 cm, weight: 72.3±8.4 kg). Before beginning, each participant was fitted with a pair of athletic shoes housing the DeepSole system. The pelvic belt was placed at the level of the iliac crests, and the walker height was self-selected and adjusted between 36-41 inches.

The experiment protocol included the following conditions: (i) Baseline: overground walking without mTPAD, (ii) mTPAD Baseline: overground walking with the mTPAD, with no external forces applied to the pelvis, and (iii) mTPAD Moments: overground walking with the mTPAD, with a frontal moment applied. Conditions (i) and (ii) were five minutes each, and condition (iii) was fifteen minutes. After condition (ii), a short break was given to each participant so that the gait phase prediction model can be retrained with their baseline data. For all three of these conditions, participants walked in a stadium pattern with the Zeno Walkway aligned with one of the stadium-shape straightaways. Therefore, participants would walk straight down the mat, turn towards their right side after exiting it, then walk back parallel to the mat. This pattern ensured that participants walked continuously and did not stop throughout each condition duration. For all participants, the following (avg±std) of laps and steps were included in training and analysis per condition: Baseline, 21.1±2.8 laps with 196.0±19.7 steps; mTPAD Baseline, 15.3±2.1 laps with 162.0±17.3 steps; mTPAD Moments, 41.7±8.2 laps with 459.2±99.5 steps.

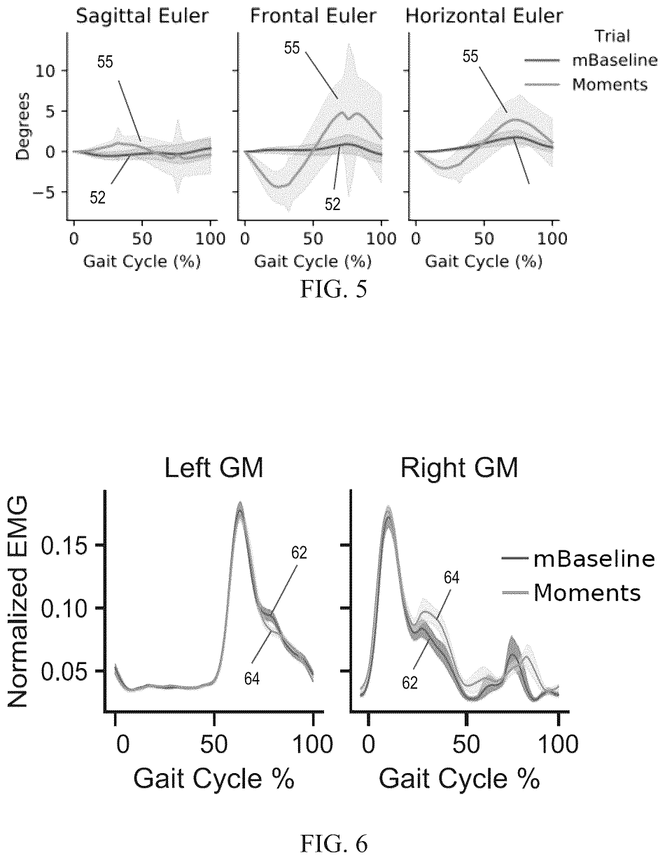

After both Baseline conditions were completed, the gait mat data were processed using the PKMAS software. These data and the time-synchronized raw DeepSole IMU and pressure data were added to the training dataset, and the prediction model was retrained for 50 epochs. Thus, the training data set included data from the participant as well as all prior participants, i.e., participant N's model was trained with the baseline data from participants 1, 2, . . . , and N. This strategy was adopted because the DeepSole prediction model did not include data from individuals walking inside the mTPAD. Optionally, the prediction can be tailored to each individual's gait by retraining the model with their baseline data.
C. Data Analysis: Once data were collected, the gait cycle prediction and timed moment applications were characterized. The changes in pelvic kinematics and GM response were evaluated.
1) Segmentation: All cyclic data were segmented and averaged to get a representative gait cycle per data type per condition per subject. The foot pressures, spatial, and temporal gait parameters were calculated and output using the ProtoKinetic software, PKMAS. Left and right heel strikes were defined as the instants left and right maximum foot pressures became non-zero.
2) Moment Application Characterization: The gait cycle percentage from the mat was time normalized using the right heel strikes; 0% corresponded to each heel strike, and 100% corresponded to the instant before the next right heel strike, assuming a constant gait cycle percentage increase. The right predicted gait cycle percentage from the DeepSole and the calculated frontal moment output by the tension optimization were segmented using the timestamps of the gait mat's right heel strikes and interpolated to 100 points.
3) Pelvis Kinematics Data: The mTPAD forward kinematics pelvic trajectories were segmented using right heel strikes. Segments were interpolated to 50 points and averaged for each condition per subject. An example of one person's representative data is shown in FIG. 5. The ranges of pelvic rotations were calculated per segmented gait cycle and averaged per condition and participant to compare the changes in pelvic motion across conditions.

FIG. 5 shows representative pelvic angles for one study participant. The outer regions 55 represent the trial where frontal moments are applied, and the inner regions 52 represent the trial where no frontal moments are applied. The solid line represents the mean of all gait cycles, and the shaded region represents the 95% confidence interval. Each graph is in degrees, and from left to right the Euler angles are taken in the pelvic sagittal, frontal, and horizontal planes. Peaks in the confidence interval represent cable configurations with more than one viable solution to the forward kinematics problem. Geometrically, there are eight solutions, but many of these lie outside the walker frame, so we can eliminate them. However, there are segments where two solutions may exist in the workspace, causing a temporary jump in the pelvic tracking.
4) sEMG Data: Raw sEMG signals were detrended, bandpass filtered, enveloped, and low pass filtered using Delsys EMGworks Analysis. Both the bandpass (20 Hz and 450 Hz) and low pass (5 Hz) filters were second-order Butterworth filters applied in both direct and reverse signal directions to avoid phase distortions, therefore being 0-phase, fourth-order filters. Processed sEMG signals were normalized across all trials with the maximum value for each sensor. The normalized signals were segmented per stride, using right heel strikes as 0% and the moment before the next ipsilateral heel strike as 100%. Stride segments were interpolated to 500 points and averaged per condition per subject. An example of these representative cycles is shown in FIG. 6. Each segmented cycle was integrated, and integrated sEMG (iEMG) values were averaged per condition and participant to compare the changes in GM activation per condition.

FIG. 6 shows representative sEMG data from one subject for the left and right GM muscles. Both subgraphs are segmented with the right heel strike representing 0% of the gait cycle. Traces 62 (with shading) represents the mTPAD trial with no frontal moments, and traces 64 (with shading) represents the mTPAD trial with frontal moments. Each solid trace 62, 64 represents the average signal for all laps of this participant, and the shaded regions around the solid traces represent the 95% confidence interval associated with the mean signal.
D. Statistical Analysis: The mTPAD Baseline data are compared to the mTPAD Moment data to evaluate effects of timed frontal moment on pelvic kinematics and GM muscle response. Before selecting the appropriate statistical test, the normality of the distributions of each data was determined using a one-sample Kolmogorov-Smirnov normality test. The Wilcoxon signed-rank test was used when significantly different from a normal distribution. One-way repeated measure analysis of variance (RM-ANOVA) tests were used when not significantly different from a normal distribution. All tests were run using Python Statsmodels and Scipy Stats, and statistical significance was defined as p<0.05. For statistical comparisons, the following notation is used: *: p<0.05; **: p<0.01; and ***: p<0.001.

### IV. Results

A. Moment Characterization: The predicted gait cycle percentage from the DeepSole system and the mTPAD's output frontal plane moment are shown in FIG. 7. The phase shift between the theoretical frontal moment based on Equation 1 and the MiPad's calculated output is 10%. The (mean±sd) for each of the parasitic forces and moments, i.e. the secondary forces that were minimized during optimization, for all participants' timed moments sessions are Fx: (−0.06±1.3) N; Fy: (1.4±1.6) N; Fz: (0.6±0.3) N; Mx: (−0.3±0.1) N m; and Mz: (−0.1±0.2) N m.

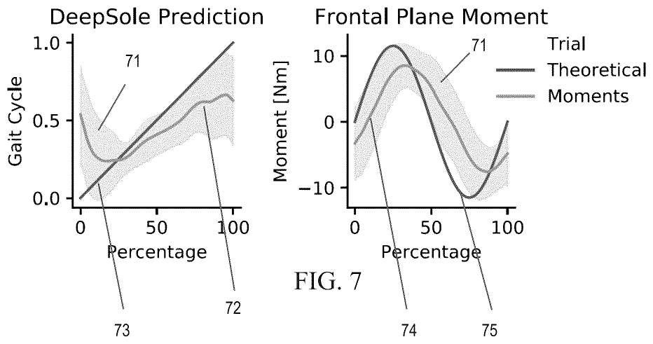

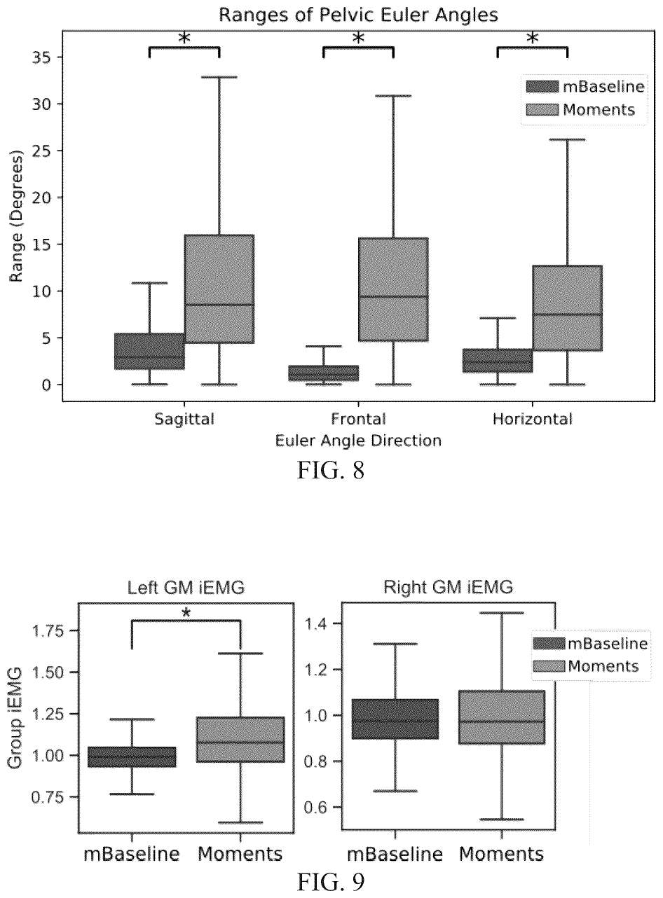

FIG. 7 shows the DeepSole gait cycle prediction and applied frontal plane moment. The x-axes of both graphs represent the gait cycle percentage segmented by right heel strikes. Solid lines represent all participants' group means of all cycles, and the shaded regions 71 represent the 95% confidence intervals. The left panel shows the DeepSole right gait cycle prediction as trace 72, and the right gait cycle percentage from the gait mat as trace 73. The right panel shows the optimized frontal moment as calculated by the mTPAD's tension solver as trace 74. The sine transform of the mat segmented gait cycle percentage is shown as trace 75. The amplitude of this sine wave is the average of all participant's amplitudes.
B. Pelvis Kinematics: The differences in Euler angles with and without the applied moment were evaluated to determine if the frontal plane moments significantly affected the pelvic range of motion. The distributions for the pelvic rotational ranges per cycle are shown in FIG. 8. For all directions, participant mean distributions for the mTPAD Baseline condition were significantly different than a normal distribution, so Wilcoxon signed ranked tests were used. For Euler angle directions, the ranges of values are significantly higher when a frontal plane moment is applied. For the sagittal plane, the corresponding group average Euler angle is significantly higher while the mTPAD is applying a frontal plane moment (M=10.1°, SD=10.6°) than when no moments are applied (M=4.6°, SD=5.8°); Z=2, p=0.025. The Euler angle corresponding to the frontal plane is significantly higher while the mTPAD is applying a frontal plane moment (M=9.9°, SD=) 10.0° than when no moment is applied (M=2.6°, SD=5.6°); Z=0, p=0.0117. The Euler angle corresponding to the horizontal plane is significantly higher while the mTPAD is applying a frontal plane moment (M=8.3°, SD=9.2°) than when no moment is applied (M=3.0°, SD=2.4°); Z=1, p=0.0173.

FIG. 8 shows the range of values per stride for all strides and all participants. The x-axis represents the three Euler angle directions, and the y-axis represents the range of degrees per stride. The mTPAD trial where no moment is applied (i.e., the baseline) is depicted as the boxes on the left half of each pair, and the boxes on the right half of each pair represent the mTPAD trial with frontal moments applied.

C. sEMGs

The differences between the mTPAD Baseline and Moment conditions were evaluated to determine if the frontal plane moments significantly affected the iEMG values for the left and right GM muscles. The GM muscles are considered pelvic stabilizers. They are primarily active during the ipsilateral leg's stance, i.e., the contralateral leg's swing, and have higher activations when individuals experience pelvic perturbations in the frontal plane. The distributions of the left and right GM iEMG values per stride for all participants are shown in FIG. 9. The left and right distributions for these iEMG values were normal for both conditions, so a one-way RM-ANOVA was used. For the right GM, there was not a significant difference between the mTPAD Baseline (M=9.19, SD=5.18) and the mTPAD Moments (M=8.81, SD=5.25) conditions; F(1.9)=0.23, p=0.64. For the left GM, there was a significant difference between the mTPAD Baseline (M=8.55, SD=4.71) and the mTPAD Moments (M=9.10, SD=4.83) conditions; F(1.9)=5.94, p=0.038.

FIG. 9 shows the group results of iEMG values per step for the left and right GM. Baseline, on the left, represents the iEMG values per stride for all subjects in the mTPAD Baseline condition. Moments, on the right, represents the iEMG values per stride for all subjects in the mTPAD Moments condition. To visualize the change in the group iEMG results, the left and right GM iEMG values were normalized by each muscle's mBaseline average. Therefore, for the left GM iEMG values, all values of the mBaseline and Moments conditions were normalized by the left GM mBaseline mean, and the same goes for the right GM. This was done for visualization of the group data, and all statistics were as described above in III.C.4: sEMG Data.

### V. Discussion

Implementing a continuous moment-based controller using a novel overground gait training device, the mTPAD, is important for user-in-the-loop gait training with overground control of pelvic movement. The effects on the mTPAD user's gait highlight the capabilities of the mTPAD's range of applications. Most overground devices only focus on body-weight augmentation, i.e., applying an upward force to unload the individual. However, the possibility for mTPAD's force application at the pelvis is not limited to the vertical axis. This device's range of force and moment application is illustrated by demonstrating that frontal plane moments can be applied. The type of force applied by the mTPAD has the flexibility of direction, and the mTPAD can alter the applied pelvic forces and moments based on the user's gait in real-time. This novel control of an overground gait training device can target specific kinematic and elicit higher muscle activation, tailoring gait training to the user.

When a frontal plane moment is applied by the mTPAD device based on the predicted gait cycle percentage as output by the DeepSole system, the phase shift error is 10% of the gait cycle. Previously, the DeepSole system has been shown to have a root mean square error of 7.2% of the gait cycle percentage. Therefore, utilizing the predicted gait cycle percentage in the mTPAD's controller to calculate the cable tensions minimally increases the delay. Synchronizing the applied pelvic forces to the gait cycle percentage using the DeepSole system is a new capability that explores various forcing functions of the gait cycle percentage. Various forces and moments can now be applied continuously at specific phases of the gait.

The possibilities for different functions and their goals are vast. Various wave transformations like a square wave, triangle wave, etc., can be implemented, or a combination of multiple sinusoidal functions can create asymmetrical or pseudorandom wrenches. These forcing functions can be motivated by specific gait needs, from applying larger forces towards one side to train individuals with an asymmetric gait to applying forces during smaller time windows to introduce variability or affect specific gait phases.

During the frontal plane intervention, all three pelvic Euler angles experienced significant increases when a frontal plane moment was applied. These increases in the range of motion for all three pelvic angles are at least 5°. These ranges are considerable, since the pelvic ranges for overground gait are around 3°, 10°, and 10° for pelvic tilt, obliquity, and rotation, respectively. These increases could be significant for children with CP, who tend to lose pelvic and hip static range of motion as they age, especially since a restriction of pelvic movement can decrease the range of motion of the knees and ankles. Initially, it was hypothesized that only the angle corresponding to the pelvic obliquity would be affected, as this is the primary plane of the wrench application. However, applying a pure frontal plane moment altered all pelvic rotations. The pelvic rotations may be coupled because the pelvis is a segment that does not rotate around its center but about the stance leg's ipsilateral hip socket. Research has shown that this coupling is more prominent when the rotation is along the frontal and horizontal planes. Other kinematic alterations which may have resulted from the applied moments can also contribute to the coupled pelvic rotations. Alterations in the lower limb or torso kinematics can also result in these coupled motions. While the mTPAD doesn't constrict the movement of the lower limbs and is a fully portable system, information on the lower limb angles and trunk range of motion are not recorded. Motion deviations of these proximal segments to the pelvic segment can also influence the other pelvic angles while the frontal plane moments are applied. It is also possible that a different pelvic force and moment profile would better isolate one pelvic motion. By applying a moment about multiple planes, it can be possible to isolate a change in only one pelvic direction. The parasitic forces and moments in the nonfrontal plane can also affect the other directions. However, these forces and moments are bound to 5 N or 5 N·m for each force and moment.

The application of a frontal plane moment was selected to highlight the capabilities of the mTPAD device. Since the GMs are considered pelvic regulators, we investigate the activation of the GMs while the frontal plane moments are applied. A significantly higher activation was found for the left GM when a frontal plane moment was applied. This increase, rather than a decrease that may be expected when provided an assistive moment, could be due to the participant's acting against this added moment to try and maintain their natural gait. However, this increased activation was not seen bilaterally with the right GM. This unilateral adaptation to the applied forces could be due to error in the applied moments. The inaccuracy of the DeepSole prediction of the gait cycle percentage is most prominent at the bounds of the segmented gait cycle, i.e., where the right heel strikes occur. The applied frontal plane moment would increase in magnitude after the right heel strike to affect the right GM, so any errors in the prediction around this event could affect the moment application. Perhaps also, more granular changes to the cyclic GM response could have been overlooked by considering the GM activation over the entire cycle. A deeper understanding of the GM response can be attained by analyzing subsections of the gait, such as Mid versus Terminal Stance. Other sEMG analysis methods could also be used, such as Statistical Parametric Mapping (SPM), which considers inter-muscle and time dependency of multiple sEMG signals.

The differing responses between the left and right GM muscles could also result from biomechanic compensations. It is possible that the footedness or handedness of the study participants, being mostly right dominant, played a role in this asymmetric moment compensation. If participants favor their right side, they may brace themselves with their right arm or have a stronger right GM muscle. Also, when a constant downward force is applied at the pelvis, users load the mTPAD handrails, which alters the force distribution through the feet. By recording the muscles in the arms or the forces between the hands and the walker grips, investigation of the compensatory strategies that individuals use becomes possible. Using a sine wave to transform the gait cycle percentage also includes a ramp up and down of the applied moment, meaning the maximum moment happens for a short period of the gait cycle. This short maximum moment duration could also affect the amount of activation change in the pelvic regulators.

To fully understand the compensatory strategies taken by the participants, it would be necessary to know how the individual loads the frame while walking. However, the current mTPAD setup does not include sensors to measure the interaction between the hands and the frame. This limitation restricts the understanding of how the applied pelvic forces are distributed through the arm handles, which requires further investigation. If pressure sensors are added to the handles, a biofeedback aspect can be incorporated to encourage users to place less weight on the frame. The device's width is wider than the instrumented walkway, so the pressure beneath two of the four wheels cannot be measured. We can gather more insight into the participants' loading strategies during different force and moment applications by adding sensors to measure these pressures. It would also be interesting to apply other wrenches to determine which best target specific muscles for strengthening and training. This can motivate training paradigms for different patient populations with specific muscle weakness, like those with cerebral palsy who experience Trendelenburg gait due to pelvic regulation defects. Special care can be taken for the gait cycle prediction algorithm for patient populations with higher gait variability. While in this case, it worked for a group of neuro-typical individuals, the accuracy may decrease when implemented with those with irregular gait. However, there is much potential for predicting a variety of users' gaits. By tailoring various interventions to the gait cycle of the individual users, this device has great potential for training people based on their specific needs and deficiencies.

Applying a moment about the pelvis while an individual walks overground facilitates investigation of a range of interventions. Not only is the direction/plane of the force/moment applied at the pelvis flexible, but different transformations from gait cycle percentage to the desired wrench can also be implemented. The ability to modify the targeted pelvic kinematics and muscle activations motivates user-specific interventions, which can improve the potential for overground gait training.

### VI. Conclusion of Chapter One

This chapter demonstrated the efficacy and effects of an innovative overground mTPAD and its novel human-in-the-loop controller that synchronized gait cycle percentage to frontal plane pelvic moments. We showed that while applying frontal plane pelvic moments overground, the range of pelvic angles in the sagittal, frontal, and horizontal planes increased. The applied pelvic moment and altered pelvic kinematics also increased the left GM muscle activation, associated with controlling pelvic obliquity. This chapter opens the door to tailoring a gait training intervention to individuals' specific needs while also considering their gait in real-time. This allows for various pelvic forces and moments to be studied during different segments of an individual's gait, putting the individual at the center of the intervention design.

Individuals with limited control or coordination of pelvic tilt during ambulation, such as those with CP who exhibit Trendelenburg gait, require physical therapy or other interventions to limit associated degeneration of muscle strength or gait patterns. Trendelenburg gait is an abnormal gait pattern classified by a dropping of the pelvis to the contralateral side while walking and is caused by a weakened gluteal musculature. Strengthening muscles that assist with pelvic stabilization during single stance can improve coordination for these individuals. These individuals can benefit from this novel training paradigm. It can strengthen the muscles associated with pelvic tilt control while also assisting the individual by limiting pelvic drop during swing, allowing for repetitive practice of a more regular gait pattern.

Chapter Two: Assessing Changes in Human Gait with a Mobile Tethered Pelvic Assist Device (mTPAD) in Transparent Mode with Hand Holding Conditions.

Robotic gait trainers provide the capability for gait training while adding the application of repeatable forces to specific joints or segments of the user's body. These robotic devices, in principle, should make minimal alterations to the user's natural gait. Hence, the transparency of each device needs to be evaluated. This chapter explores the effects of walking in a mobile Tethered Pelvic Assist Device (mTPAD) in a zero-force mode. Eight neuro-typical adults walked in three conditions to evaluate changes in their natural gait due to the device and holding its handrails. The changes in spatial and temporal gait parameters and lower limb and arm muscle activations were characterized. Our results showed that walking in mTPAD in a zero-force mode was not significantly different from baseline treadmill walking for all recorded peak muscle activations and gait parameters, highlighting the mTPAD's transparency. When the users hold the device's frame, peak bicep activation increases, and the users take slower, narrower steps. However, frame holding did not significantly alter any lower limb peak muscle activations. This chapter verifies the transparency of the mTPAD's zero-vertical force controller and isolates changes in the muscle activations and gait patterns caused by holding the device's frame. This investigation can motivate the design and control of other user-propelled robotic gait trainers. This chapter also facilitates studies with mTPAD to separate gait changes caused by force interventions from changes due to holding the device.

### I. Introduction

Robotic gait training devices have been shown to improve gait, including gait velocity and step length. Special consideration has to be taken to ensure that these devices, which intend to assist the user, do not interfere or constrain the user's natural motion. Device induced gait adaptations can be caused by added inertia, joint misalignment, and implemented control methods. Therefore, it is important to evaluate the effects of the gait training device itself before applying forces and torques.

Cable-driven robotic gait trainers (CDRGT) are beneficial due to the low weight of the cables, flexibility to attach to the human body, and minimal consideration of joint misalignment. The transparency of some CDRGTs has been shown as they do not alter the user's gait velocity, step length or pelvic range of motion (RoM). However, some CDRGTs do alter gait parameters, like step length or ankle dorsiflexion, even when compensating for additional mass.

The inventors have created the mobile Tethered Pelvic Assist Device (mTPAD), a CDRGT that routes cables from a posterior rollator to a user worn pelvic belt. This is a parallel, end-effector based robotic gait trainer. As a robotic gait trainer, it is important to ensure that the physical structure of the device minimally constrains or alters the user's natural movement. Therefore, an important step in device validation is characterizing the effects of mTPAD on gait of users in transparent mode, i.e. zero pelvic forces applied.

Not only should device transparency be evaluated, but the effects of holding the mTPAD frame on the user's gait need to be characterized. Walking with a rollator can differ from regular walking. For neuro-typical individuals, walking with a rollator reduces knee flexion and ankle dorsiflexion and increases forward torso and hip flexion. Significant reductions in lower limb surface electromyographic data were seen when neuro-typical individuals loaded a rollator with about 21% of their body weight. Individuals with Parkinson's Disease and those with Huntington's Disease walked with more variability and slower gait speed when walking with an assistive device. Elderly individuals using a walker for the first time have increased stride length and gait velocity. Therefore, the underlying mTPAD structure of a posterior rollator may alter users' gaits.

A. Motivation and Novelty:

When designing a robotic device for rehabilitative or assistive purposes, minimum alteration to the natural movement of the user caused by device architecture should be a key goal. Therefore, there is a need to understand the changes to the gait parameters and lower limb muscle responses caused by using the mTPAD robotic device in a transparent control mode. By evaluating the device's effects in a transparent mode, the level of transparency of the robotic device can be determined. Since the propulsion of the device is also done by the individual during overground gait, effects of holding the frame of the mTPAD also need to be characterized. This knowledge can shed light on the behavioral changes caused by walking in a portable CDRGT, as well as any other self-propelled robotic gait trainers.

This chapter investigates the transparency of the mTPAD's zero force controller and the effects of walking with the mTPAD, both with and without holding its frame. Lower limb and arm muscle responses and spatiotemporal gait characteristics are evaluated while participants walk with mTPAD in a transparent mode. This characterization of the gait and muscle responses to using and holding the mTPAD isolates effects of mTPAD in transparent mode from holding the device frame during gait. Therefore, when implementing non-zero force control strategies, the impacts of specific forces can be separated.

### II. System Setup

A. mTPAD Hardware

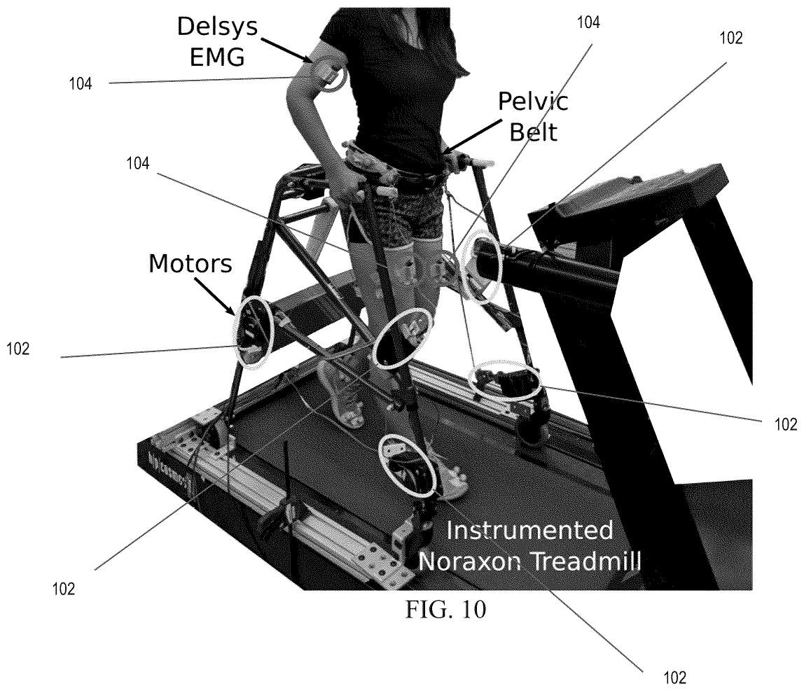

The mTPAD is a parallel, cable-driven system with seven motorized cables, shown in FIG. 10. The mTPAD is described herein, and additional details of mTPAD can be found in D. M. Stramel and S. K. Agrawal, “Validation of a Forward Kinematics Based Controller for a mobile Tethered Pelvic Assist Device to Augment Pelvic Forces during Walking,” Proceedings—IEEE International Conference on Robotics and Automation, pp. 10133-10139, Institute of Electrical and Electronics Engineers (IEEE), September 2020, which is incorporated herein by reference in its entirety.

The physical structure of this device is a posterior rollator (NIMBO, Inspired by Drive, California, USA), making the mTPAD lightweight and portable. Custom motor housings mount Dynamixel servo motors (XM430W350-R, ROBOTIS, Seoul, South Korea) to the frame, which route cables to a pelvic belt. Each motor is rated for an output of 2.9 Nm and is coupled with a cable spool of radius 4 cm, allowing a maximum tension of nearly 70 N per cable. The tensions are controlled to apply three-dimensional forces and moments at the pelvis. Cable tensions are calculated using a custom LabView script run on a myRI01900 (National Instruments, Texas).

FIG. 10 shows the mTPAD mounted to an instrumented Noraxon treadmill, which records pressure values beneath the treadmill belt. Motor mounts, depicted in circles labeled 102, route cables to the pelvic belt worn by the user. sEMG data are recorded using Delsys Trigno Avanti sensors, depicted in circles labeled 104.

B. mTPAD Controller

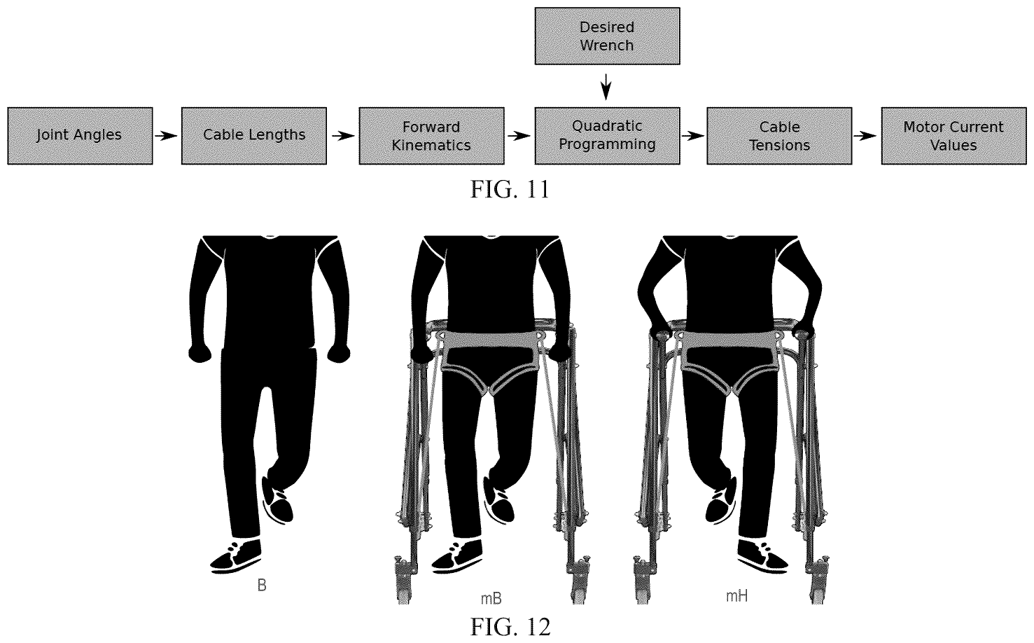

The mTPAD utilizes an open-loop forward kinematics based high-level controller, as illustrated in FIG. 11.

FIG. 11 is a block diagram of the mTPAD open-loop high-level controller, run at 40 Hz. Each of the seven motor angles are read, and used to calculate each corresponding cable length. The principle of trilateration is used to calculate the forward kinematics of the participant's pelvis using the cable lengths as inputs. Once the participant's pelvic position and orientation have been calculated, optimization of cable tensions is done using quadratic programming and the input desired three dimensional forces and moments at the pelvic center. Desired cable tensions are converted to desired motor torques, and are sent to each motor. The servo motors have internal PID controllers to minimize error of the output torque.

Quadratic programming is used to optimize the over-actuated system's cable tensions in mTPAD. The following tension constraints are used in the quadratic programming scheme.

min ƒ(T) (a)

where

ƒ(T)=T^{T}T, (b)

with

JT=F (c)

and

$${T}_{i , min} \leq {T}_{i} \leq {T}_{i , max} ; \{ \begin{matrix}- 5 N \leq {F}_{x , y} \leq 5 N \\ - 0.5 N \leq {F}_{z} \leq 0.5 N \\ - 5 N \cdot m \leq {M}_{x , y , z} \leq 5 N \cdot m\end{matrix} \qquad ( d )$$

where T is a 7×1 vector of the tension in each of the seven cables, J is a 6×7 Jacobian matrix constructed using the coordinates of the cable exit points on the walker frame and the cable attachment points on the pelvic belt. F is the 6×1 force-moment profile associated with the optimized tension solution, Tmin=1 N for all i to guarantee taut cables, and Tmax=35 N for all i to ensure safety. For this experiment, Fz was bounded by ±0.5 N to ensure no vertical loading was applied to the pelvis and that the device acted in a transparent mode i.e., applied minimum forces to the participant. This allows us to study the effects of the mTPAD structure in transparent mode independent from the effects of the user holding the mTPAD frame.

### III. Experimental Setup

Data were collected from eight neuro-typical adults to evaluate the effects of the mTPAD transparent mode and holding the mTPAD frame on natural gait. There were three experimental conditions performed on a treadmill: baseline walking, mTPAD transparent mode, and holding mTPAD while in transparent mode. This was performed while the mTPAD device was mounted to a treadmill, as overground walking requires the user to self-propel the mTPAD. Since overground walking without holding the device is not possible, we could not isolate effects of arm interaction overground.

Comparing the three conditions facilitates understanding of: (i) the effects of the cable-driven mTPAD in transparent mode on treadmill gait, and (ii) the effects of holding the frame of the mTPAD while treadmill walking. These results will shed light on how walking is effected by the mTPAD transparent mode. It will also illustrate any gait changes caused by holding the mTPAD frame, which will be useful for other self-propelled gait trainers.

To understand how walking within the mTPAD frame alters a user's gait, multiple devices were used to synchronously measure different types of data, as shown in FIG. 10. Spatial and temporal gait parameters were collected using an instrumented PhysTread Pressure Treadmill (Noraxon, Arizona). An array of 3120 Pressure sensors are located beneath the treadmill belt, which sample data at 100 Hz. An accompanying MR3.12 software (Noraxon, Arizona) was used to calculate the gait parameters.

Dual differential Delsys Trigno Avanti Sensors recorded surface electromyography (sEMG) signals of left and right Bicep (Bi), Tricep (Tri), Rectus Femoris (RF), Bicep Femoris (BF), Vastus Lateralis (VL), Gastrocnemius (Ga), Soleus (Sol), and Tibialis Anterior (TA) muscles at 2148 Hz. In order to synchronize the sEMG and treadmill data, a digital signal from the treadmill was sent to a VICON Lock Labdevice, which triggered the VICON Nexus software to start recording. To reduce noise of the sEMG signals, sterile 70% Isopropyl Alcohol prep pads were used to exfoliate and clean skin. Custom Delsys double sided adhesive was used to adhere electrodes to the skin, and medical tape was applied over electrodes to the skin to ensure contact during gait. For synchronization purposes, the sEMG signals were recorded using VICON Nexus software (VICON, United Kingdom), but other motion capture data were not recorded.

A. Protocol

Eight neuro-typical adults (6 females, 2 males, age: 27±3.1 years, weight: 65.0±5.3 kg, height: 167.8±8.1 cm) participated in and completed the experiment. Before beginning the experiment, all participants were informed of all study procedures and given the opportunity to ask any questions regarding the study. The experiment protocol consisted of three conditions: (i) Baseline (B): treadmill walking without the mTPAD attached to the treadmill; (ii) mTPAD Baseline (mB): treadmill walking with the mTPAD attached and in a transparent force mode without the participant holding the mTPAD frame; and (iii) mTPAD Holding (mH): holding the frame of the mTPAD while walking in the mTPAD applying a transparent pelvic force. The protocol conditions are illustrated in FIG. 12 with, from left to right, representations of Baseline (B), mTPAD Baseline (mB), and mTPAD Holding (mH). Each condition consisted of five minutes of continuous walking at the same self-selected speed. Condition (i) was collected, then condition orders of (ii) and (iii) were randomized. A short break was given to the participants between conditions.

B. Data Analysis
1) Gait Characteristics Data: All continuous data were segmented, and outcome measures were averaged per data type per condition per subject. Data segmentation was done using the right foot pressure data output from the MR3.12 software. Right heel strike was calculated as the time when maximum right foot pressure became nonzero. The spatial and temporal gait parameters were averaged and output using the MR3.12 software.
2) sEMG Data: Raw sEMG signals were detrended, bandpass filtered, enveloped, and low pass filtered using python. The bandpass (20 Hz and 450 Hz) and low pass (5 Hz) filters were second-order Butterworth filters that were applied in both direct and reverse directions of the signals to avoid phase distortions, thus becoming fourth order filters. Processed sEMG signals were normalized using the maximum value for each sensor across all three conditions. The normalized signals were time normalized using right heel strikes. For one stride, this was done by finding the treadmill timestamp of a right heel strike (ti₀) and the treadmill timestamp before the next right heel strike (ti_{f}), then finding the first sEMG signal timestamp after ti₀ and the last sEMG signal timestamp before ti_{f}. The sEMG signal in the bounds of ti₀ to ti_{f} was then interpolated to 500 points so that an average signal could be determined. The peak sEMG values per stride were calculated, and these values were averaged per condition per participant.

C. Statistical Analysis

To evaluate the effects of the mTPAD transparent mode and holding the mTPAD frame on the user's natural gait, B, mB, and mH conditions were compared. The normalities of the data distributions were determined using a Kolmogorov-Smirnov test. When significantly non-normal, the Wilcoxon signed-rank test was used, otherwise, a one-way repeated measure analysis of variance (RM-ANOVA) test was used. If a significant effect was found, post-hoc pairwise comparisons were completed using a Holm-Bonferroni correction to limit Type I errors in the results. All tests were run using Python Statsmodels and Scipy Stats, and statistical significance was defined as p<0.05. For statistical comparisons, the following notation is used: *: p<0.05; **: p<0.01; and ***: p<0.001.

### IV. Results

A. Gait Characteristics

The effects of the mTPAD transparent mode and holding the mTPAD frame on the stride length, step width, and stride time were evaluated. These parameters were calculated per left and right step and averaged per condition per subject. A main effect significance was found in all three gait variables. For stride length H(2)=12.0, p<0.01; for step width F(2,14)=19.38, p<0.001; and for stride time F(2,14)=9.29, p<0.01.

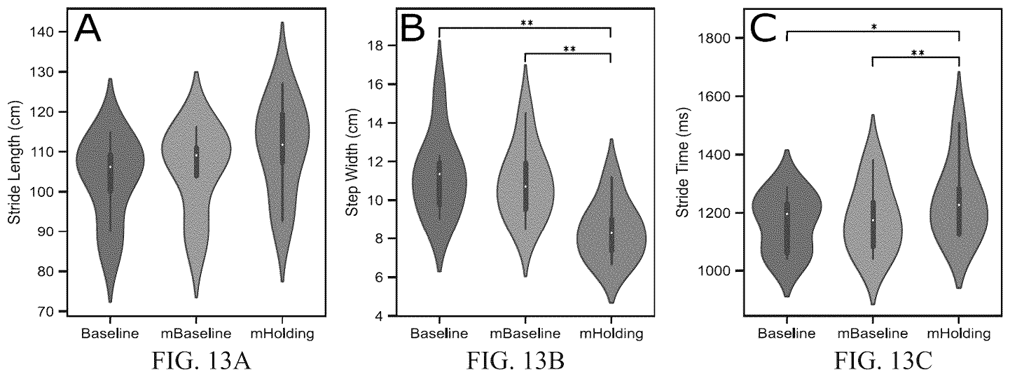

FIG. 13A shows stride length in cm, FIG. 13B shows step width in cm, and FIG. 13C shows stride time in ms per condition. Each shape's shaded region represents the distributions of the values per condition. The small central circles represent the median, and the central vertical lines show quartile ranges.

For the stride length, shown in FIG. 13A, the corrected post-hoc comparisons (mean±std) showed that there was no significant differences between: B (103.2±10.1 cm) and mB (105.7±10.4 cm), p=0.345; B and mH (111.2±11.6 cm), p=0.223; and mB and mH, p=0.283.

For the step width, shown in FIG. 13B, the corrected posthoc comparisons showed that there was no significant difference between B (11.3±2.09 cm) and mB (10.9±1.9 cm), p=0.207. However, during mH (8.4±1.5 cm) participants took significantly narrower steps than both the B, p=0.0042, and mB, p=0.0086, conditions.

For stride time, shown in FIG. 13C, the corrected posthoc comparisons showed no significant difference between B (1165.0±97.4 msec) and mB (1180.0±118.0 msec), p=0.416. However, during mH (1241.5±133.6 msec) participants took significantly slower steps than both B, p=0.0178, and mB, p=0.0013, conditions.

B. sEMG

Differences between peak values per condition were assessed to evaluate the mTPAD's transparent controller and determine the effects holding conditions have on the arm and lower limb muscles. The only muscles that showed a significant difference were the left and right biceps. The rmANOVA p values per muscle are shown in Table I below. Main effects were found for the left: H(2)=9.75, p<0.01, and right: F(2,14)=4.082, p<0.05, bicep peak values.

TABLE I
GROUP AVERAGED PEAK VALUES
MEAN ± STD PER MUSCLE.

| | | | | | Stat | p |
|---|---|---|---|---|---|---|
| Muscle | Side | Baseline | mBaseline | mHolding | Test | Value |
| Bi | Left | 0.11 ± 0.07 | 0.1 ± 0.05 | 0.21 ± 0.11 | notN | 0.008 |
| Bi | Right | 0.12 ± 0.05 | 0.1 ± 0.06 | 0.21 ± 0.16 | N | 0.04 |
| BF | Left | 0.29 ± 0.17 | 0.26 ± 0.17 | 0.3 ± 0.16 | N | 0.746 |
| BF | Right | 0.36 ± 0.16 | 0.32 ± 0.15 | 0.38 ± 0.13 | notN | 0.417 |
| Ga | Left | 0.38 ± 0.15 | 0.4 ± 0.18 | 0.45 ± 0.19 | N | 0.356 |
| Ga | Right | 0.38 ± 0.22 | 0.36 ± 0.22 | 0.44 ± 0.25 | notN | 0.607 |
| RF | Left | 0.22 ± 0.12 | 0.25 ± 0.16 | 0.2 ± 0.08 | N | 0.739 |
| RF | Right | 0.23 ± 0.15 | 0.23 ± 0.16 | 0.22 ± 0.12 | N | 0.995 |
| Sol | Left | 0.32 ± 0.18 | 0.27 ± 0.14 | 0.34 ± 0.2 | N | 0.469 |
| Sol | Right | 0.45 ± 0.19 | 0.41 ± 0.17 | 0.47 ± 0.18 | N | 0.508 |
| TA | Left | 0.41 ± 0.16 | 0.42 ± 0.16 | 0.45 ± 0.14 | N | 0.667 |
| TA | Right | 0.34 ± 0.17 | 0.38 ± 0.17 | 0.39 ± 0.14 | N | 0.51 |
| Tri | Left | 0.14 ± 0.12 | 0.12 ± 0.09 | 0.1 ± 0.05 | notN | 0.687 |
| Tri | Right | 0.1 ± 0.07 | 0.09 ± 0.08 | 0.11 ± 0.07 | N | 0.712 |
| VL | Left | 0.18 ± 0.15 | 0.27 ± 0.23 | 0.24 ± 0.18 | N | 0.358 |
| VL | Right | 0.16 ± 0.11 | 0.29 ± 0.21 | 0.27 ± 0.18 | notN | 0.197 |

notN: Not normal Data, N: Normal Data. Bolded p-values significant.

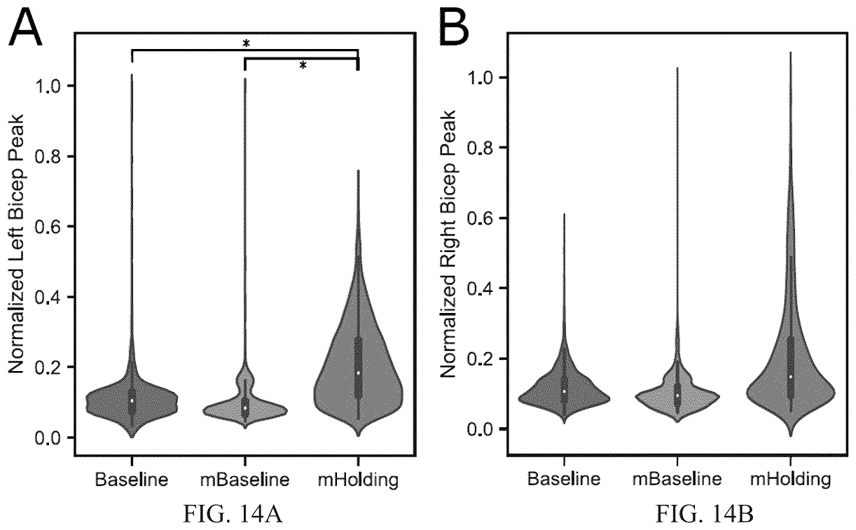

The peak averages per condition for the left and right biceps are shown in FIG. 14A and FIG. 14B. The normalized (FIG. 14A) left and (FIG. 14B) right bicep peaks per condition. Each shape's shaded region represents the distributions of the peak values per condition. The small central circles represent the median, and the central vertical lines show quartile ranges.

For the right bicep, the corrected post-hoc comparisons showed that there was no significant differences between: B (0.12±0.054) and mB (0.11±0.059), p=1.0; B and mH (0.21±0.16), p=0.11; and mB and mH, p=0.31. For the left bicep, the corrected post-hoc comparisons showed that there was no significant difference between B (0.11±0.073) and mB (0.097±0.045), p=1.0. However, during mH (0.21±0.11), left bicep peak activation was significantly higher than both B, p=0.12, and mB, p=0.026, conditions.

### V. Discussion

This evaluation of gait characteristics and muscle responses while walking with the mTPAD in various conditions characterizes the effects and transparency of the parallel, cable-driven structure and hand-holding on the user's gait. In this chapter, we have shown that walking with the mTPAD's transparent mode controller does not alter the user's gait. When the user holds the frame of the mTPAD, left bicep muscle activation increases, and the user takes narrower, slower steps. This experiment was important to characterize the gait alterations caused by walking with the mTPAD and holding the mTPAD frame.

Walking in the mTPAD with transparent forces does not alter lower limb or arm muscle activation compared to treadmill gait at the same speed. This unaltered gait cannot be said for all robotic gait trainers and is one of the benefits of using a low-inertia cable-driven architecture. The lightweight pelvic belt and routing cables add minimal constraints to the user, allowing them to ambulate without restriction.

Even when holding the device's frame, lower limb muscle activation remains unaltered. Other studies have shown that walking with forearm rests lessens muscle activation in lower limbs. However, these reductions in muscle activity were most likely due to the unloading of 20% of the user's body weight on the handles, which were anterior to the user. The mTPAD frame is a posterior rollator with the handles placed laterally on each side of the user. This suggests that this type of rollator does not cause the user to alter their body weight force distribution, which more resembles the user's baseline.

The left bicep did show increased activation when holding the mTPAD. All participants in this experiment were righthand dominant, which could be the reason for the asymmetric bicep increase. By instrumenting the handles with force or pressure sensors, loading asymmetry can be studied. It is also possible that since a main effect was found for the right bicep, but pairwise comparisons between conditions were not significantly different, the effect size was too small. The Holm-Bonferroni correction used in the pairwise comparison is conservative, so perhaps a larger group of participants was needed. Similar to the muscle responses, the spatiotemporal gait parameters were not altered when walking in the mTPAD without holding the frame. This is promising, as the frame of the mTPAD, while not contacting the user, still creates a physical barrier around the pelvis, restricting its overall workspace. A restricted pelvic workspace has the potential to decrease step length and step width and gait velocity. However, these gait changes were not seen while walking with the mTPAD, illustrating the lack of restriction caused by the mTPAD architecture and transparent controller. When the participants laterally held the frame of the mTPAD, this caused narrower, slower steps at the same treadmill speed. Similar effects of decreased step width have been seen in post-stroke adults when treadmill walking with lateral handrails. The lateral hand-holding of the mTPAD increases the individual's base of support, which can cause a narrower step width. Since the three conditions were done using the same self-selected treadmill speed per person, a significantly slower stride time would imply a longer stride length. A significance was found for the main effect of the conditions, but pairwise condition comparisons did not show a significant difference. Once again, this could be a limitation of the number of participants.

The gait and muscle activation changes seen when holding the mTPAD frame can also be considered a characterization of how gait changes when holding a posterior rollator. Therefore, this is not only useful to other roboticists who aim to design user-propelled, transparent gait trainers, but also to individuals who use a rollator for stability. A posterior rollator can be a better choice compared to anterior walkers because they do not alter lower limb muscle activation.

Along with the small number of participants who completed this experiment, other limitations exist. Optionally, forearm muscle responses can be accounted for. As these muscles are proximal to the hands, characterizing their activation can be beneficial. Although no differences in upper arm muscles between the Baseline and mTPAD Baseline conditions were found, the mTPAD could affect arm swing when not holding the frame. Optionally, interaction forces between the hands and the mTPAD frame can be accounted for. This would be an exciting avenue of investigation, as loading may change with applied pelvic forces or handedness. Optionally, three dimensional ground reaction forces can be accounted for. Investigating these can provide a more rigorous investigation of the impact of mTPAD on gait. The baseline walking condition was on the treadmill, which may not fully represent overground gait. Overground ambulation is the target functional activity of the mTPAD. Still, overground gait does not allow for the statistical isolation of the hand holding as a variable, so this work had to be done on the treadmill.

### VI. Conclusion of Chapter Two

This chapter explored the effects of walking with the mTPAD in transparent mode and while holding its frame on muscle activation and spatiotemporal gait parameters. The inventors discovered that walking with the mTPAD in transparent mode did not alter the gait parameters or lower limb muscles. However, holding the frame of the mTPAD caused participants to take narrower, slower strides and their peak bicep activation per stride increased. However, lower limb activation did not change, so posterior rollators can allow a more natural gait than other types of walker. This chapter sheds light on how holding the mTPAD device, which can be important for future overground walking applications, alters gait parameters but not lower limb muscle activation. This can be important to interpreting future mTPAD results when various pelvic forces are explored and allows us to isolate effects of pelvic forces from effects of holding the mTPAD.

Individuals with muscle weakness, gait irregularities, or balance deficits benefit from a walking aide and regular physical therapy. The mTPAD's ability to provide walking assistance and resistance or training forces at the pelvis makes the mTPAD an all-in-one rehabilitation device. Now that effects of the frame and holding interaction have been characterized, various training paradigms can be planned and analyzed.

### CONCLUSION OF THE PATENT APPLICATION

While the present invention has been disclosed in Chapter One and Chapter Two above with reference to certain embodiments, numerous modifications, alterations, and changes to the described embodiments are possible without departing from the sphere and scope of the present invention, as defined in the appended claims. Accordingly, it is intended that the present invention includes not only the described embodiments, but that it also has the full scope defined by the language of the following claims, and equivalents thereof.

What is claimed is:

1. An apparatus for rehabilitating or assisting ambulation of a user, the apparatus comprising:
a walker frame;
at least one sensor configured to generate data that is indicative of the user's gait;
a first controller configured to predict the user's gait based on the data generated by the at least one sensor;
a pelvic belt or harness shaped and dimensioned to fit securely on the user's pelvis;
a plurality of cables, each of which has a first end affixed to the pelvic belt or harness;
a plurality of actuators that are mounted with respect to the frame, wherein each of the actuators is configured to, when energized, pull on a respective one of the cables; and
a second controller programmed to, based on the gait predictions made by the first controller, control the energization of the plurality of actuators at times that are synchronized with phases of the user's gait so that the plurality of actuators pull on the respective cables at respective times in a coordinated sequence.

2. The apparatus of claim 1, wherein the at least one sensor comprises at least one pressure-sensitive sensor configured for positioning beneath the user's right foot and at least one pressure-sensitive sensor configured for positioning beneath the user's left foot.

3. The apparatus of claim 1, wherein the first controller maps a predicted gait cycle percentage to an applied pelvic moment using the equation
$${M}_{y} = ( \text{.1} * \underline{{m}_{BW}} ) * ( 0.5 * \underline{{w}_{P}} ) * \underline{\underline{sin}} ( \frac{2 * π * {p}_{GC}}{100} ) \qquad ( 1 )$$
where M_{y} is the frontal plane pelvic moment in Nm, m_{BW} is the participant's body weight in N, ω_{P} is the participant's pelvic width in m, and p_{GC} is the participant's predicted right gait cycle output from the gait prediction system from 0 to 100%.

4. The apparatus of claim 3, wherein after a goal moment has been calculated using equation (1), the second controller optimizes for tensions of the cables using quadratic programming.

5. The apparatus of claim 1, wherein the first controller and the second controller are both implemented using the same hardware.

6. The apparatus of claim 1, wherein each of the actuators comprises a motor.

7. The apparatus of claim 1, further comprising a plurality of wheels positioned to support the walker frame.

8. The apparatus of claim 1, wherein the plurality of cables includes seven cables configured such that two cables route to each of two lateral extremes of the pelvic belt or harness, and three cables route to a posterior extreme of the belt or harness, wherein the seven cables provide control of six degrees of freedom at the pelvis, with the force and moment profiles that are applied being customizable in both magnitudes and force and moment directions.

9. The apparatus of claim 1, wherein the second controller is further programmed to localize the pelvic center with respect to the frame using a forward kinematics approach that relies on the lengths of the cables.

10. The apparatus of claim 1, wherein the second controller is programmed so that the coordinated sequence assists ambulation.

11. The apparatus of claim 1, wherein the second controller is programmed so that the coordinated sequence applies a force in opposition to a given muscle in order to rehabilitate the given muscle.

12. A method for rehabilitating or assisting ambulation of a user, the method comprising:
sensing at least one first pressure beneath the user's right foot;
sensing at least one second pressure beneath the user's left foot;
predicting the user's gait based on the sensed at least one first pressure and the sensed at least one second pressure; and
energizing a plurality of motors at a plurality of times that are synchronized with phases of the user's gait so that the plurality of motors pull on respective cables at respective times in a coordinated sequence,
wherein each of the cables has a first end affixed to a pelvic belt or harness that is shaped and dimensioned to fit securely on the user's pelvis, and
wherein timing of the energizing is based on the gait predictions.

13. The method of claim 12, wherein a predicted gait cycle percentage is mapped to an applied pelvic moment using the equation
$${M}_{y} = ( \text{.1} * \underline{{m}_{BW}} ) * ( 0.5 * \underline{{w}_{P}} ) * \underline{\underline{sin}} ( \frac{2 * π * {p}_{GC}}{100} ) \qquad ( 1 )$$
where M_{y} is the frontal plane pelvic moment in Nm, m_{BW} is the participant's body weight in N, ω_{P} is the participant's pelvic width in m, and p_{GC} is the participant's predicted right gait cycle output from the gait prediction system from 0 to 100%.

14. The method of claim 12, wherein the cables are configured such that two cables route to each of two lateral extremes of the pelvic belt or harness, and three cables route to a posterior extreme of the belt or harness, wherein the cables provide control of six degrees of freedom at the pelvis, with the force and moment profiles that are applied being customizable in both magnitudes and force and moment directions.

15. An apparatus for rehabilitating or assisting ambulation of a user, the apparatus comprising:
a walker frame;
at least one pressure-sensitive sensor configured for positioning beneath the user's right foot and at least one pressure-sensitive sensor configured for positioning beneath the user's left foot, wherein the pressure-sensitive sensors are configured to collectively generate data that is indicative of the user's gait;
a first controller configured to predict the user's gait based on the data generated by the pressure-sensitive sensors;
a pelvic belt or harness shaped and dimensioned to fit securely on the user's pelvis;
at least seven cables, each of which has a first end affixed to the pelvic belt or harness;
a plurality of motors that are mounted with respect to the frame, wherein each of the motors is configured to, when energized, pull on a respective one of the cables; and
a second controller programmed to, based on the gait predictions made by the first controller, control the energization of the plurality of motors at times that are synchronized with phases of the user's gait so that the plurality of motors pull on the respective cables at respective times in a coordinated sequence.

16. The apparatus of claim 15, wherein the first controller maps a predicted gait cycle percentage to an applied pelvic moment using the equation
$${M}_{y} = ( \text{.1} * \underline{{m}_{BW}} ) * ( 0.5 * \underline{{w}_{P}} ) * \underline{\underline{sin}} ( \frac{2 * π * {p}_{GC}}{100} ) \qquad ( 1 )$$
where M_{y} is the frontal plane pelvic moment in Nm, m_{BW} is the participant's body weight in N, ω_{P} is the participant's pelvic width in m, and p_{GC} is the participant's predicted right gait cycle output from the gait prediction system from 0 to 100%.

17. The apparatus of claim 16, wherein after a goal moment has been calculated using equation (1), the second controller optimizes for tensions of the cables using quadratic programming.

18. The apparatus of claim 15, wherein the first controller and the second controller are both implemented using the same hardware.

19. The apparatus of claim 15, wherein the cables are configured such that two cables route to each of two lateral extremes of the pelvic belt or harness, and three cables route to a posterior extreme of the belt or harness, wherein the cables provide control of six degrees of freedom at the pelvis, with the force and moment profiles that are applied being customizable in both magnitudes and force and moment directions.

20. The apparatus of claim 15, wherein the second controller is further programmed to localize the pelvic center with respect to the frame using a forward kinematics approach that relies on the lengths of the cables.
